(19) United States
(12) Patent Application Publication
(10) Pub. No.: US 2026/0246192 A1
(43) Pub. Date: Aug. 20, 2026

(54) TOLERANCE COMPENSATION, SHIELDING, AND SEALING FOR BUSBAR CONNECTIONS

(71) Applicant: TE Connectivity Solutions GmbH, Schaffhausen (CH)

(72) Inventors: Joshua T. Shoemaker, Winston Salem, NC (US); Kevin John Peterson, Winston Salem, NC (US); Ram Kishore Venkatesan, Winston Salem, NC (US); Matthew Bryan Hitchcock, Middletown, PA (US); Rameshkumar Rangaswamy, Winston Salem, NC (US)

(73) Assignee: TE Connectivity Solutions GmbH, Schaffhausen (CH)

(21) Appl. No.: 19/539,128

(22) Filed: Feb. 13, 2026

Related U.S. Application Data
(60) Provisional application No. 63/759,656, filed on Feb. 18, 2025.
(60) Provisional application No. 63/803,147, filed on May 9, 2025.

(51) Int. Cl. H01R 13/52; H01R 4/36; H01R 13/6581

(52) U.S. Cl. CPC H01R 13/5202; H01R 4/36; H01R 13/6581

(57) ABSTRACT

A conductor assembly adapted for use with an electric vehicle includes a first conductive busbar, a second conductive busbar, and a flexible conductor electrically connecting the first and second busbars. The first and second busbars include exposed end portions to which the flexible conductor is electrically connected. The assembly further includes an insulating flexible sleeve installed over the flexible conductor and covering the exposed end portions of each of the first and second busbars.

### CROSS-REFERENCE TO RELATED APPLICATION

This application claims priority to U.S. Provisional Patent Application No. 63/759,656, filed Feb. 18, 2025, and U.S. Provisional Patent Application No. 63/803,147, filed May 9, 2025, the entire disclosures of which are incorporated by reference herein.

### FIELD OF THE INVENTION

The present disclosure relates to an electrical conductor assembly, and more particularly, to an electrical conductor assembly including a pair of rigid conductive busbars connected via a flexible conductor for improving tolerance compensation, as well as to shielding and sealing methods for use with the same.

### BACKGROUND

Within the electric vehicle (EV) space, manufacturers are in need of systems and methods to decrease cost and weight while increasing performance. One significant way to achieve this is by from moving away from relatively heavy, stranded copper cable, and towards the implementation of lightweight aluminum busbar. However, due to the rigid nature of busbars, many automakers are hesitant to move to a full busbar solution. More specifically, the use of busbars as the sole or primary source of conductors within an electrical system increases tolerance requirements during manufacturing and assembly. Furthermore, solutions utilizing busbars may provide additional challenges such as ensuring adequate shielding and sealing of the joints or interfaces of these systems.

### SUMMARY

A conductor assembly adapted for use with an electric vehicle includes a first conductive busbar, a second conductive busbar, and a flexible conductor electrically connecting the first and second busbars. The first and second busbars include exposed end portions to which the flexible conductor is electrically connected (e.g., welded). The assembly further includes an insulating assembly, such as a flexible polymer sleeve installed over the flexible conductor and covering at least the exposed end portions of each of the first and second busbars.

### BRIEF DESCRIPTION OF THE DRAWINGS

The invention will now be described by way of example with reference to the accompanying Figures, of which:

FIG. 1 is a side perspective view of a conductor assembly or charging cable according to an embodiment of the present disclosure attached to an electronic component, such as a charging port of an electric vehicle;

FIG. 2 is a side perspective view illustrating a first step in a method of preparing the conductor assembly according to an embodiment of the present disclosure;

FIG. 3 is a side perspective view illustrating a second step in a method of preparing the conductor assembly according to an embodiment of the present disclosure;

FIG. 4 is a side perspective view illustrating a third step in a method of preparing the conductor assembly according to an embodiment of the present disclosure;

FIG. 5 is a side perspective view illustrating a fourth step in a method of preparing the conductor assembly according to an embodiment of the present disclosure;

FIG. 6 is a side perspective view illustrating a partially assembled conductor assembly including a pair of rigid busbars joined by a flexible conductive section, according to another embodiment of the present disclosure;

FIG. 7 is a side perspective view illustrating the conductor assembly according of FIG. 6 after a flexible cover or sleeve has been applied thereto;

FIG. 8 is a side perspective view illustrating the conductor assembly of FIGS. 6 and 7 after the flexible cover or sleeve has been secured thereto via a pair of fasteners;

FIG. 9 is a perspective view illustrating a conductor assembly according to another embodiment of the present disclosure;

FIG. 10 is a perspective view of a layered copper component which may be used as the flexible conductor connecting to at least one busbar according to an embodiment of the present disclosure;

FIG. 11 is a perspective view of a multi-stranded copper wire which may also be used as the flexible conductor for connecting to at least one busbar according to an embodiment of the present disclosure;

FIG. 12 is a perspective view of a completed conductor assembly including a shielded busbar connected to a stranded conductor according to another embodiment of the present disclosure;

FIG. 13 is a cross-sectional view of the conductor assembly of FIG. 12;

FIG. 14 is a cross-sectional view of the stranded cable of FIGS. 12 and 13 in a state of preparation for use in the assembly of FIG. 12;

FIG. 15 is a perspective view of the prepared cable of FIG. 14;

FIG. 16 is a cross-sectional view of the rigid busbar of FIGS. 12 and 13 in a state of preparation for use in the assembly of FIG. 12;

FIG. 17 is a perspective view of the prepared busbar of FIG. 16;

FIG. 18 is perspective view of the prepared cable and busbar as arranged during a joining or welding operation to be performed thereon;

FIG. 19 is an illustration of an assembly step including the application of an insulating cap or sleeve over a welded joint resulting from the welding step represented in FIG. 18;

FIG. 20 is a cross-sectional view of the assembly of FIG. 19;

FIG. 21 is a perspective view illustrating a metallic shielding sleeve or shell fitted over the assembly of FIGS. 19 and 20;

FIG. 22 is a cross-sectional view of the assembly of FIG. 21;

FIG. 23 is another cross-sectional view the assembly of the preceding figures wherein the shielding shell has been secured to a remainder of the assembly via fasteners;

FIG. 24 is a perspective view illustrating a final assembly step including the application of heat shrink over the joint of the assembly of the preceding figures;

FIG. 25 is an exploded view of a conductor assembly including a shielded busbar connected to a stranded conductor according to another embodiment of the present disclosure;

FIG. 26 is a cross-sectional view of the conductor assembly of FIG. 25; and

FIG. 27 is cross-sectional view of a conductor assembly including a shielded busbar connected to a stranded conductor according to another embodiment of the present disclosure.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth in order to provide a thorough understanding of the disclosed embodiments. However, it is apparent that one or more embodiments may also be implemented without these specific details.

Embodiments of the present disclosure include systems and methods for filling a gap between a fully rigid busbar solution and current stranded cable wiring solutions, particularly those used in automotive manufacturing. The design provides tolerance compensation that allows for movement along all three axes while retaining the advantages of the busbar. More specifically, the tolerance compensation solution described herein provides flexibility to a small section of the charging harness, allowing manufacturers to assemble the harness into a vehicle without the requirement of maintaining tight tolerances. Based on the length of the braided or flexible section of the harness section, this solution has an added benefit of controlling how much tolerance is gained along each axis.

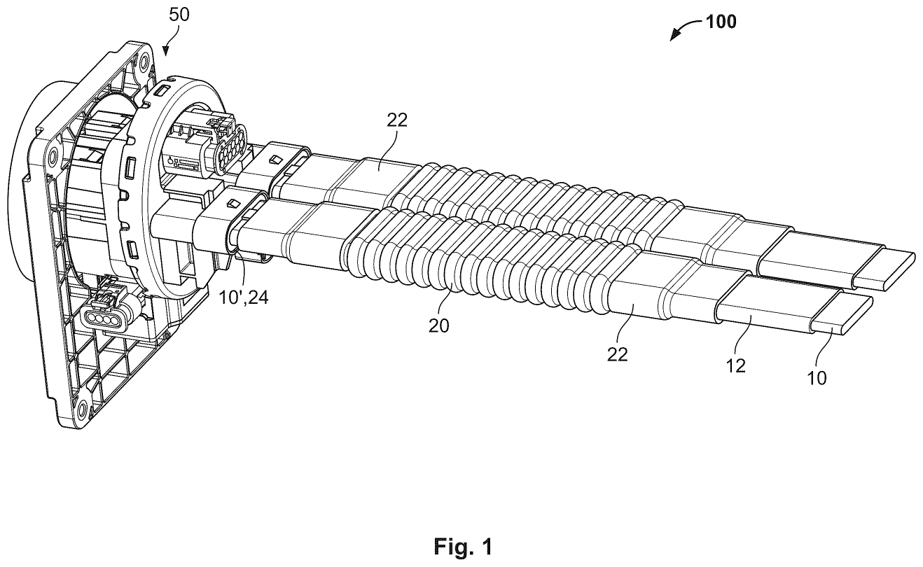

Referring generally to FIGS. 1-5, an exemplary portion of a conductor assembly 100 according to an embodiment of the present disclosure is provided. The embodiment includes an electrical component, such as a charging port 50 of an EV. The conductor assembly 100 comprises, by way of example, a charging harness adapted to mate with the charging port 50.

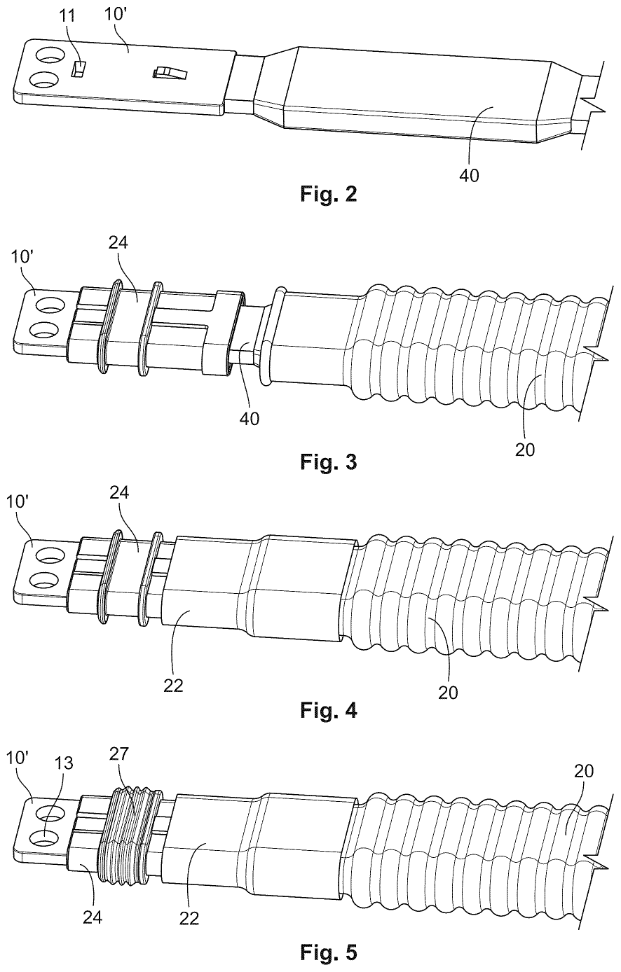

A pair of busbars 10, 10′ (e.g., light-weight aluminum or copper busbars, see also FIGS. 2-5) are provided for carrying electrical current through a majority of the system or vehicle. The busbar 10 may be insulated via a jacket or insulating cover 12. The busbar 10′ may be adapted for insertion into, and mating with, the charging port 50 (e.g., a terminal thereof).

In order to improve tolerance compensation and achieve multi-axis flexibility of the otherwise rigid busbars 10, 10′, a flexible section of the assembly 100 includes a flexible cover 20 arranged over a flexible conductor (e.g., a section of braided copper or aluminum cable or wire 40, as shown in FIG. 2) that is provided between the first and second rigid busbars 10, 10′. Attached to the end of the terminating busbar 10′ proximate the charging port 50 is an adapter 24 configured to interface (e.g., form a snap fit) with a housing of the charge port 50, securing the assembly 100 to the charge port. Shrink wrap 22 may be provided on either end of the flexible cover 20 for sealing the assembly and maintaining the position of the cover.

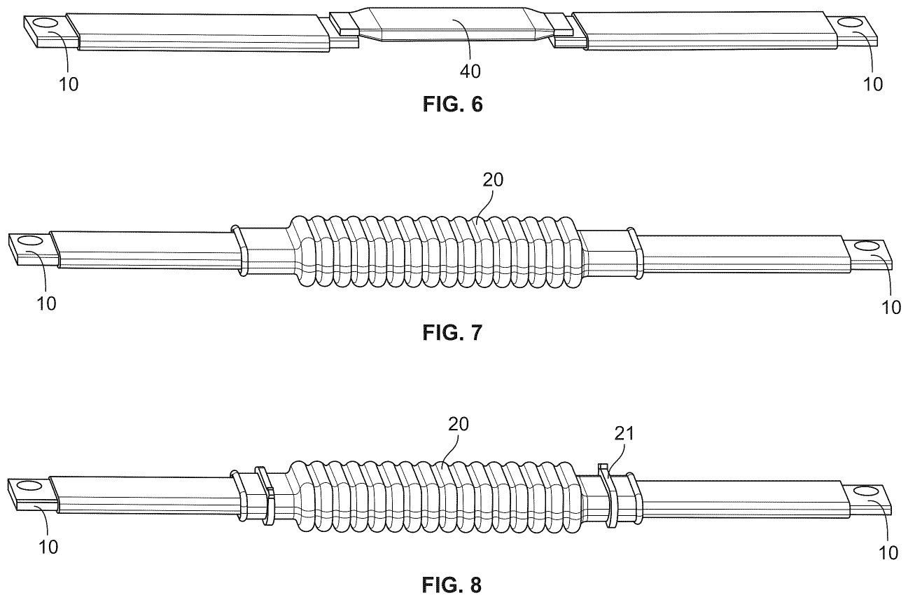

Referring specifically now to FIGS. 2-5, an exemplary process for constructing the charging plug side of the conductor assembly 100 is shown. With reference to FIG. 2, the braided, flexible cable 40 may be butt welded or ultrasonically welded to the terminating busbar 10′ or busbar tab. A similar welding operation may also be performed between the flexible cable 40 and the busbar 10, as shown in FIG. 1 (see also FIG. 6). The busbar 10′ may include features (e.g., a recess 11) for enabling a snap fit connection to the adapted 24.

As shown in FIG. 3, once the terminating busbar 10′ is secured to the flexible cable 40, the protective flexible cover 20 is arranged thereover. Next, the adapter or plug 24 is fitted over the busbar 10′, and may be mechanically fixed thereto via the above-described complementary features (e.g., the recess 11 as shown in FIG. 2, as well as a corresponding protrusion formed internally within the plug 24).

With reference to FIG. 4, the heat shrink or heat shrink tubing 22 may be applied over both the flexible cover 20 and an end portion of the adapter 24. This seals the arrangement, preventing moisture and debris from reaching the flexible cable 40. The use of the heat shrink tubing 22 further aids in maintaining the position of the flexible cover 20 during use, including while being manipulated during installation into a system. In an embodiment, the heat shrink or heat shrink tubing 22 may have a conductive ink forming a layer integrated with the heat shrink 22, for example on a surface of the heart shrink 22, to provide additional shielding. While the use of heat shrink 22 is shown, it should be understood that other fastening means, such as cable ties or clamps, may also be used depending on sealing requirements, by way of non-limiting example only.

Finally, as shown in FIG. 5, a seal 27 may be arranged on or over the adapter 24. The seal 27 is configured to form a seal with the interfacing plug on the charging port 50 (or other electrical component). The finished assembly 100 may then be snap-fit into the charging port 50 before bolting the busbar 10′ to an internal conductive terminal (e.g., via the illustrated through holes 13).

With reference now to FIGS. 6-8, in another embodiment of the present disclosure, similar tolerance compensation assemblies may be utilized anywhere along a length of a busbar 10. More specifically, these embodiments are not limited to being formed in immediate proximity to electrical components, such as shown in the embodiment of FIGS. 1-5. By way of non-limiting example, a rigid copper or aluminum busbar according to an embodiment of the present disclosure may be directed attached or connected to an electrical component (e.g., a charging inlet), with a flexible section attached to an end of the busbar distal to the electrical component. Further, it should be understood that embodiments of the present disclosure are not limited to a single flexible section or joint along a given connection or harness. Rather, any number of flexible sections may be utilized as the application dictates. For example, a flexible section may be utilized at an intermediate or central position along a harness, with a second flexible section being used proximate an electrical component.

With specific reference to FIG. 6, a pair of busbars 10 are provided and joined together via the braided cable 40. As set forth above, butt welding or ultrasonic welding may be used to attached exposed ends of each busbar 10 to the braided cable 40. Similar to the preceding embodiments, the flexible cover 20 is then fitted over the braided cable 40 as shown in FIG. 7. With reference to FIG. 8, cable ties, zip ties or other fasteners 21 may be used to secure the ends of the cover 20 to each of the busbars 10. In other embodiments, for example, heat shrink, seals or sealing caps may also be implemented without departing from the scope of the present disclosure in order to improve sealing and isolation performance.

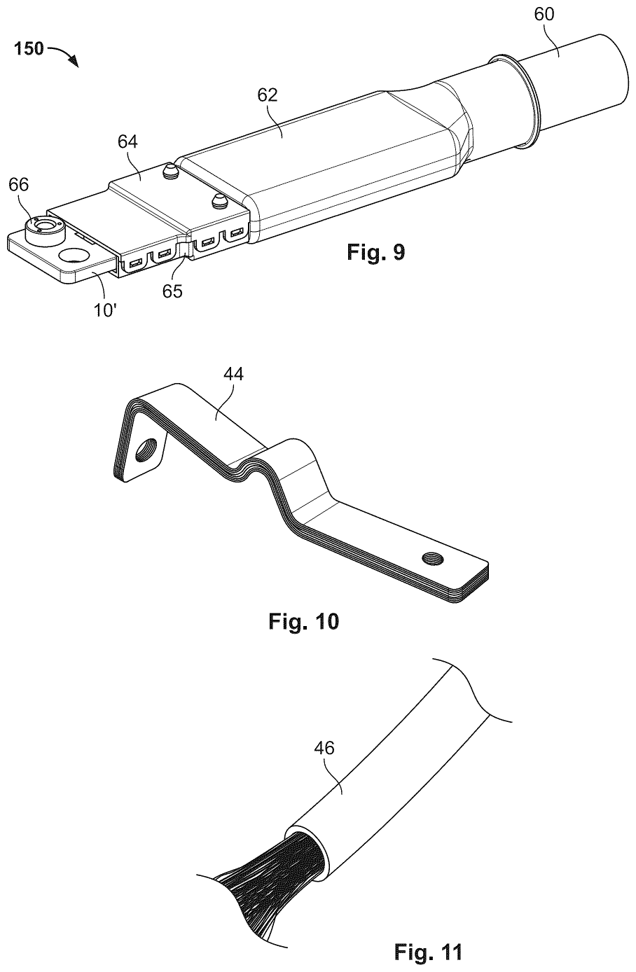

FIG. 9 illustrates another assembly 150 according to an embodiment of the present disclosure which utilizes a round busbar or solid round cable 60. The round bar 60 may be butt welded or ultrasonically welded to, for example, the braided cable 40 as described above. Afterward, an insulating sleeve or boot 62 may be fitted over the resulting welded joint. Once the boot 62 is fitted, a two piece housing 64, 65 may be snap fit over an end of the boot 62, securing it in place. This arrangement may be suitable for dry environments where sealing is less of a significant concern. In the exemplary embodiment of FIG. 9, the terminating busbar 10′ is shown with a fastener 66. The fastener 66 may be used to secure the busbar 10′ to, for example, the charging port 50 shown in FIG. 1, or more specifically, to a conductive terminal thereof.

As shown in FIGS. 10 and 11, embodiments of the present disclosure are not limited to flexible braided cable. Rather, other forms of flexible conductors may be utilized without departing from the scope of the present invention. For example, a flexible, layered copper structure 44 (FIG. 10) or a standard round-wire cable 46 (FIG. 11) may also be used to achieve multi-axis flexibility of a conductor assembly between rigid busbars.

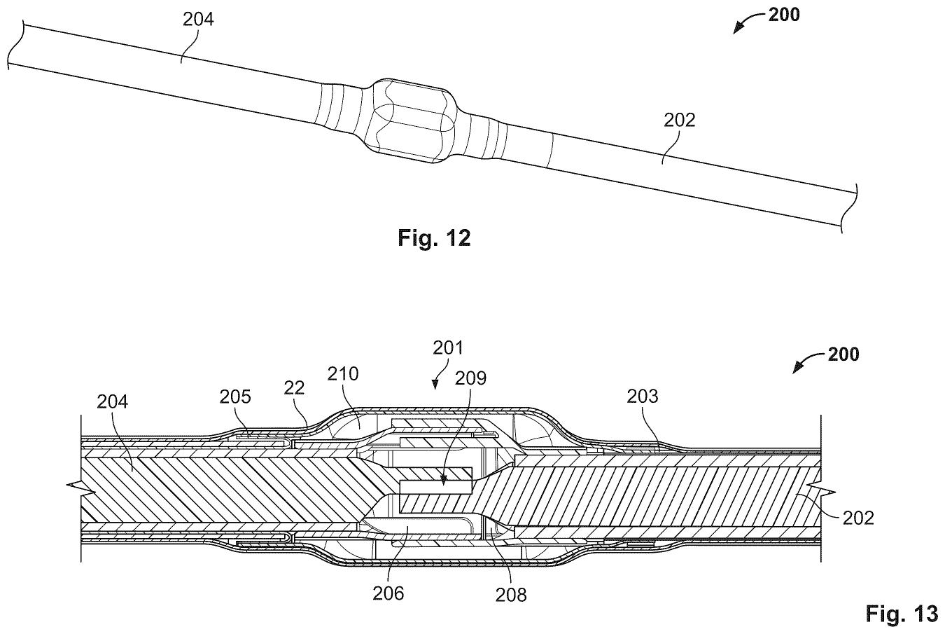

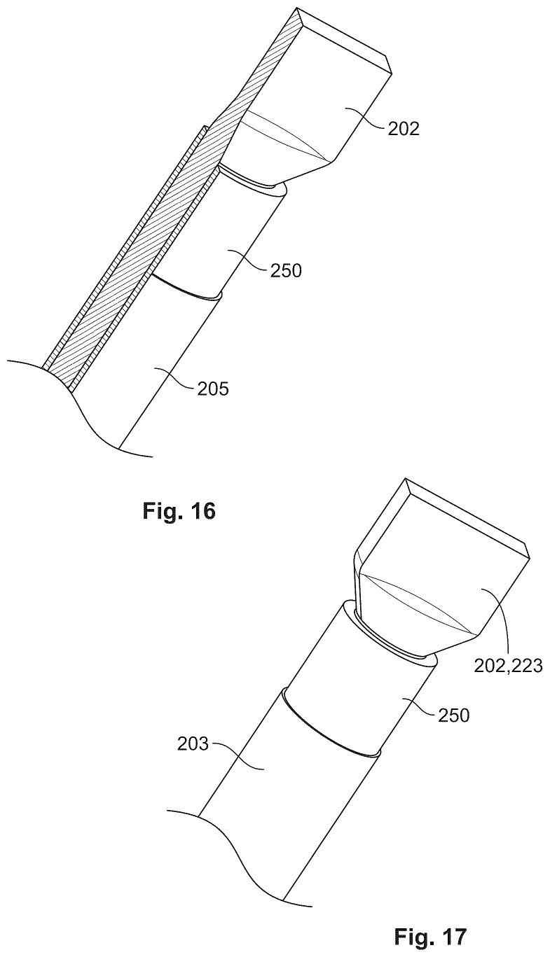

While the above embodiments impart flexibility and tolerance compensation to otherwise rigid busbar conductor assemblies, challenges still remain. In particular, the joining of these flexible and rigid conductors present challenges with respect to electrical isolation and sealing from environmental conditions. FIGS. 12-27 illustrate improved methods for sealing the above-described busbar to flexible conductor portions.

As shown in FIGS. 12 and 13, an exemplary completed conductor assembly 200 according to an embodiment of the present disclosure includes a rigid, shielded aluminum busbar 202 attached to a flexible stranded copper cable 204, with heat shrink 22 surrounding the resulting joint therebetween. In an embodiment, as described above, the heat shrink 22 may have a conductive ink forming a layer integrated with the heat shrink 22, for example on a surface of the heart shrink 22, to provide additional shielding.

The cross-sectional view of FIG. 13 illustrates the joined busbar 202 and copper cable 204 welded together at a joint 209. A resulting joint insulating assembly 201 is formed from a plurality of distinct components. For example, a two piece, snap fit plastic cap assembly includes first and second cap halves 206, 208, and is fitted over the welded joint 209 to provide electrical isolation. The joint assembly 201 further includes a metallic shielding sleeve 210 fitted over the cap assembly 206, 208. The sleeve 210 electrically contacts a shielding layer 205 of the copper cable 204 as well as a shielding layer 203 of the busbar 202 for electrically isolating of the joint.

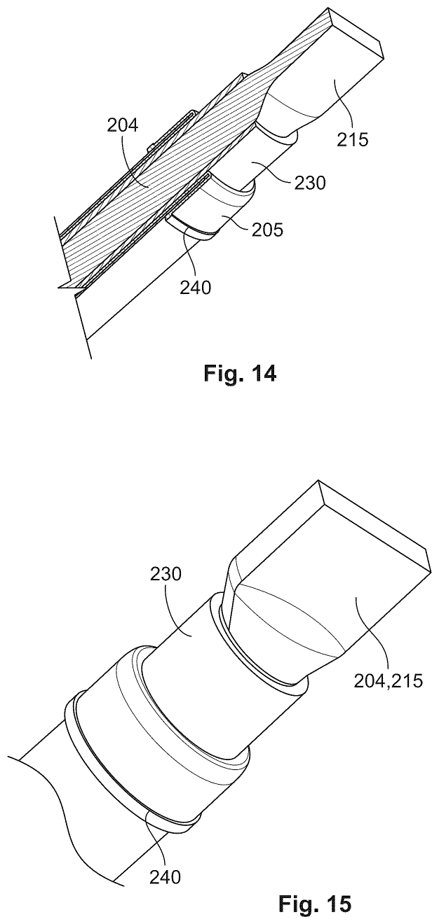

FIGS. 14-17 illustrate preparation steps of the busbar 202 and cable 204 prior to soldering the weld joining 209 and the formation of the remaining joint assembly 201. Specifically, as shown in FIGS. 14 and 15, a shielding layer 205 and an inner ferrule 240 of the cable 204 are exposed for contact with the shielding sleeve 210. The inner insulation 230 of the cable 204 extends beyond the exposed shield in a direction toward the exposed conductor end 215. The busbar 202 is prepared in a similar fashion, with a shielding layer 203 exposed therefrom, and its insulation 250 extending therebeyond in the direction of its exposed end 223.

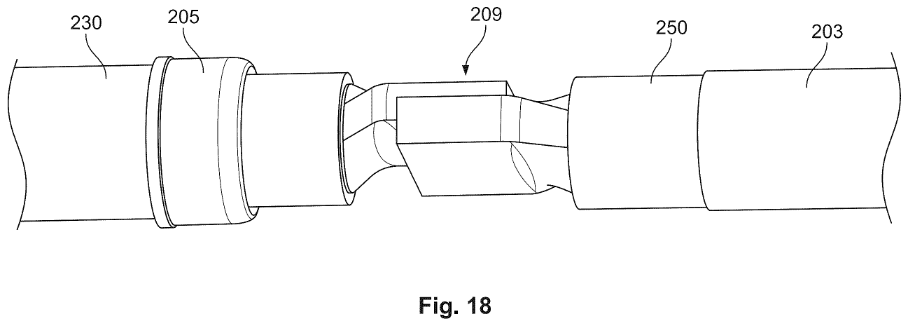

Referring to FIGS. 18-24, after preparation of the busbar 202 and cable 203 described above with respect to FIGS. 14-17, production of the assembly 200 will now be described.

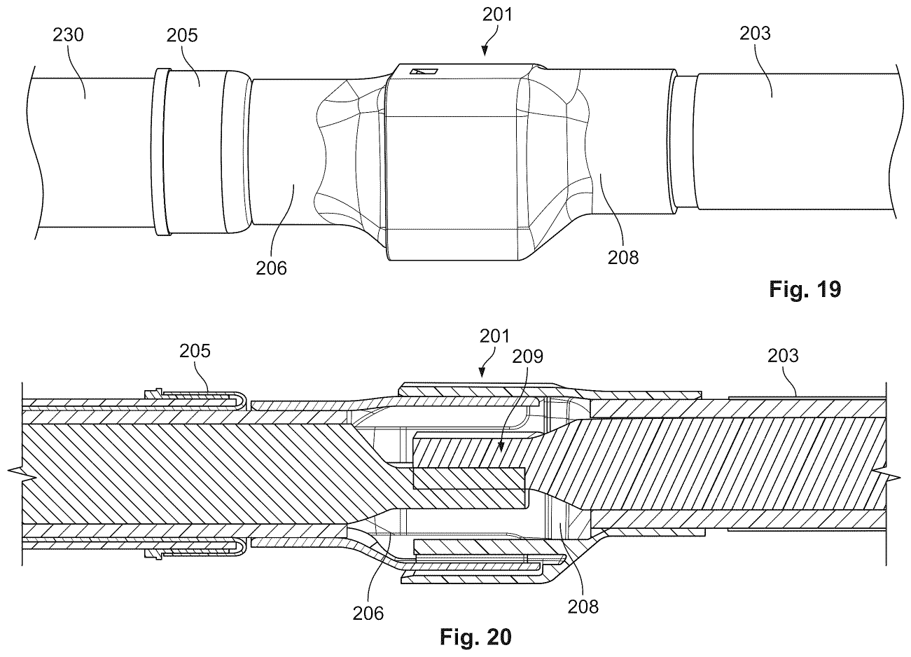

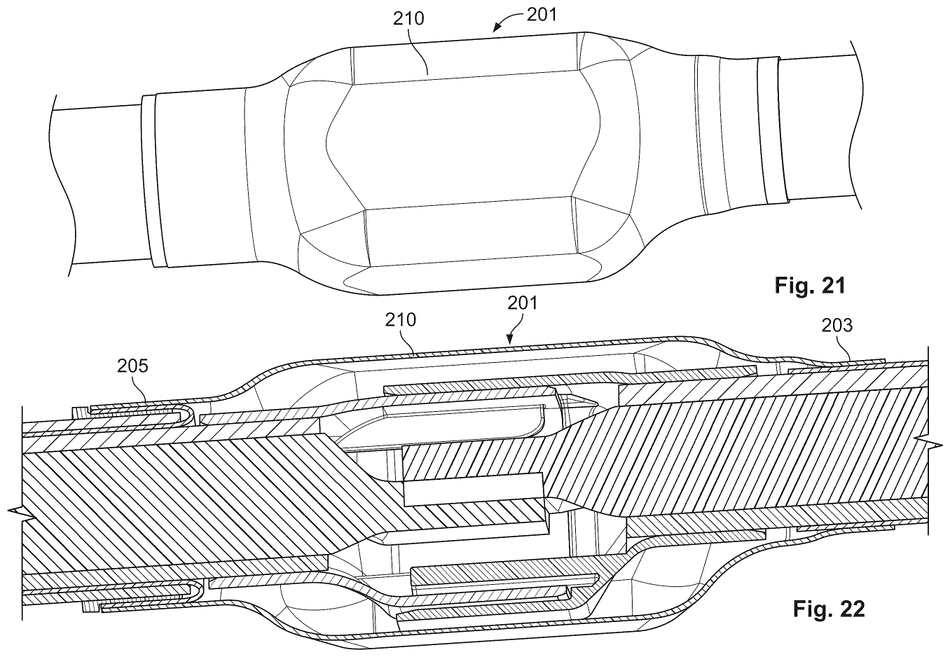

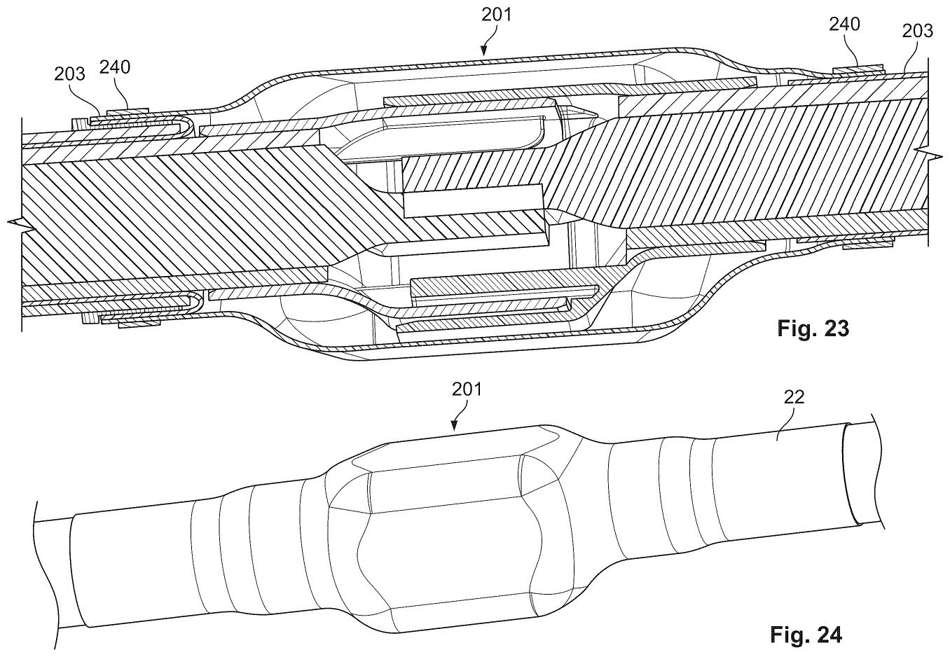

As shown in FIG. 18, the exposed ends 215, 223 of the cable 204 and the busbar 202 and are welded together, as described above with respect to the previous embodiments of the present disclosure. Next, the joint assembly 201 is formed. Specifically, the two piece insulating caps 206, 208 are snap-fit together over the soldered joint 209, as illustrated in FIGS. 19 and 20. Once the caps 206, 208 are in position, the metallic shield sleeve 210 is slid or fitted over the assembly and placed into contact with the exposed shielding layers 205, 203 of the cable 204 and busbar 202, as shown in FIGS. 21 and 22. With reference to FIG. 23, metal ties 240 may be used to tighten the shielding cover or sleeve 210 into secure contact with the exposed shielding layers 203, 205. Finally, as shown in FIG. 24, heat shrink 22 may be applied over the assembly providing further sealing and insulation benefits. As with other embodiments described herein, the heat shrink or heat shrink tubing 22 may have a conductive ink forming a layer integrated with the heat shrink 22, for example on a surface of the heart shrink 22, to provide additional shielding.

The joint assembly 201 including the shielding sleeve 210 is shown positioned inside the heat shrink 22 in the embodiment of FIGS. 13, 22, and 23. In another embodiment, the joint assembly 201, including the shielding sleeve 210, could be positioned outside of the heat shrink 22, formed for example as a bundle shield across the joint.

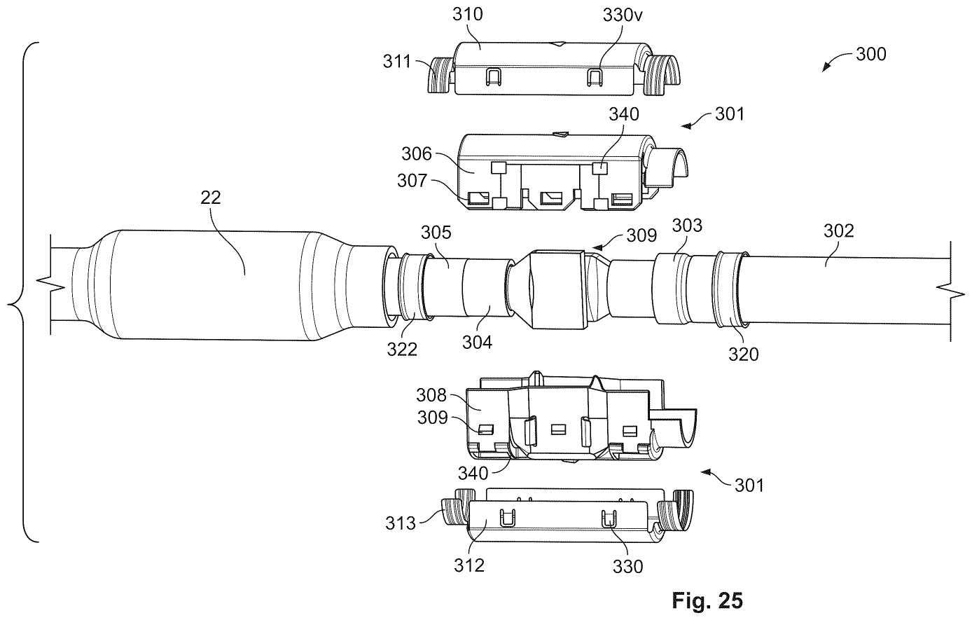

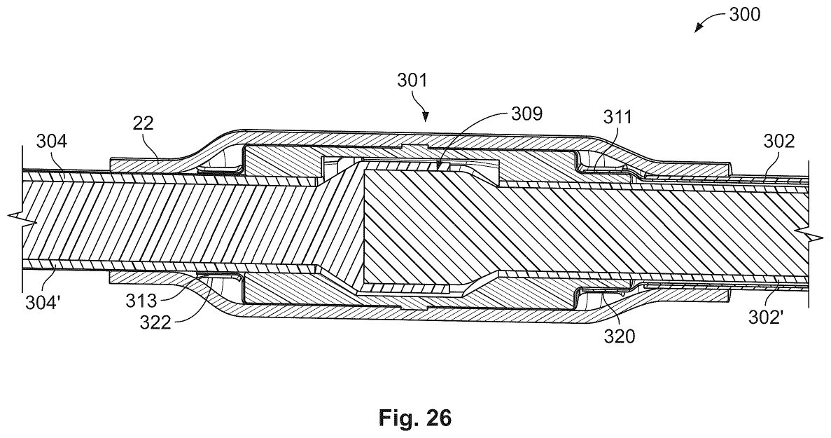

Referring to FIGS. 25 and 26, another conductor assembly 300 according to an embodiment of the present disclosure is shown. The exemplary conductor assembly 300 according to an embodiment of the present disclosure includes a rigid, shielded busbar 304 (e.g., a round busbar) attached to a flexible stranded cable 302, with heat shrink 22 surrounding the resulting joint therebetween (see FIG. 26). The cable 302 includes an exposed shielding layer 303 and a ferrule 320 adapted to be fit over the exposed shielding layer. Likewise, the busbar 304 includes an exposed shielding layer 305, and also has a ferrule 322 fitted thereon and adapted to be arranged over the exposed shielding layer.

The exploded or disassembled view of FIG. 25 illustrates the joined busbar 304 and the cable 302 welded together at a joint 309. A resulting joint insulating assembly 301 is formed from a plurality of distinct components. For example, a two piece, snap fit plastic housing assembly includes first and second isolating housing halves 306, 308, and is fitted over the welded joint 309 to provide electrical isolation. The isolating housing halves 306, 308 are selectively joined together via the illustrated complementary latches and catches 307, 309 formed thereon.

The joint assembly 301 further includes a two-part metallic shielding sleeve comprising a pair of shielding halves 310, 312 adapted to be fitted over the cap assembly 306, 308. Each shielding half 310, 312 includes locking features 330 for engaging with complementary locking features 340 formed on the first and second isolating housing halves 306, 308. Crimping ends 311, 313 are formed on each end of the shielding halves 310, 312 and are adapted to be crimped over or onto the shielding layers 303, 305 via a respective ones of the ferrules 320, 322 in the assembled state of the assembly 300 shown in FIG. 26.

Still referring to FIGS. 25 and 26, a brief description of a process of manufacturing the assembly 300 is described herein. As shown, with the cable 302 and the busbar 304 welded together, the isolating halves 306, 308 are fitted thereover to define an isolating housing surrounding the joint 309. It is noted that the isolating housing 306, 308 is arranged over an insulation layer 302′ of the cable 302 and an insulation layer 304′ of the cable 302 and busbar 304, respectively. Next, the shielding halves 310, 312 are fitted (e.g., snap-fit) over the isolating housing 306, 308. The crimping ends 311, 312 of each half 301, 312 are arranged in contact with the exposed shielding layers 303, 305. The ferrules 320, 322 are then moved over the crimping ends 311, 312, after which they are mechanically crimped radially inward, ensuring reliable electrical connection between the shielding layers 303, 305 of the cable 302 and busbar 304, and the shield housing 306, 308. Finally, the heat shrink 22 may be positioned over the joint 309, and secured in-place via the selective application of heat thereto. As with other embodiments described herein, the heat shrink or heat shrink tubing 22 may have a conductive ink forming a layer integrated with the heat shrink 22, for example on a surface of the heart shrink 22, to provide additional shielding.

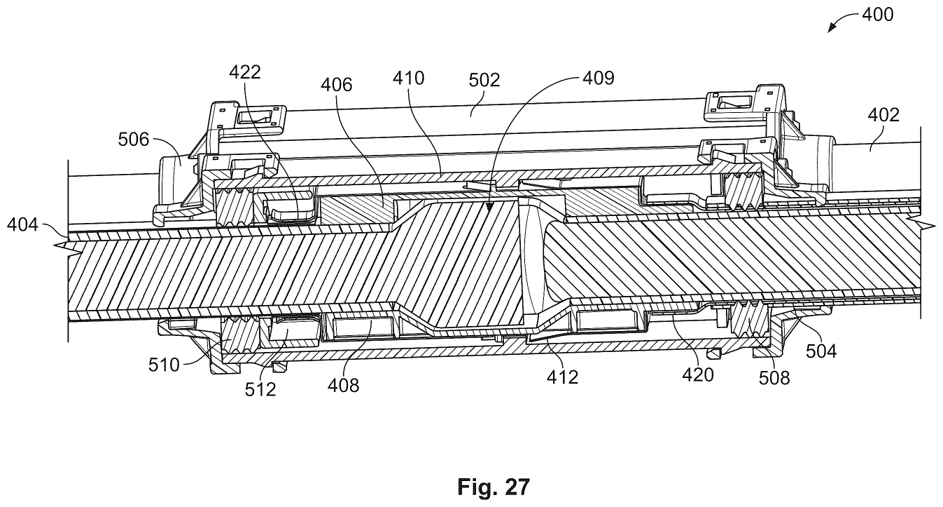

Referring now to FIG. 27, another conductor assembly 400 according to an embodiment of the present disclosure is shown. As with the previous embodiments, a flexible conductor 402 (e.g., a cable) is joined to a busbar 404 at a joint 409. An insulating housing 406, 408 (e.g., a two-part polymer housing) is arranged over the joint 409. A shield 410, 412 (e.g., a two-part metallic housing) is fitted over the insulating housing, with ends thereof placed in contact with, or arranged over, exposed portions of a shielding layer of each of the cable 302 and busbar 304, as set forth in detail above with respect to the previous embodiments of the present disclosure. Ferrules 420, 422 may be arranged over ends of the shield 410, 412 for securing the shield in electrical contact with the shielding layers.

As distinct from other embodiments of the present disclosure, the embodiment of FIG. 27 includes an exterior sealing assembly 500, including a main body 502, a pair of end caps 504, 506, a pair of seals 508, 510 and a spacing element 512. Specifically, the main body 502 (e.g., a polymer body) may be fitted over the above-described joint assembly, and specifically the shield 410, 412. The main body 502 may be comprised of two components snap-fit over the shield, or may be a monolithic hollow element slid over the shield. With the main body 502 in position over the joint 409, the seal 508 may be inserted or slid into one end thereof. As shown, the seal 508 is fitted over an inner insulating layer of the cable 402 for forming a seal therewith. An outer surface of the seal 508 sealingly contacts an inner surface of the main body 502. The seal 508 is axially retained or located via an inwardly protruding stop or wall of the main body 502, as shown. Once positioned as illustrated, the end cap 504 is fitted (e.g., snap fitted) over the main body 502. This secures the position of the seal 508, ensuring reliable sealing and isolation of the joint from the external environment.

Similarly, on the busbar side of the assembly, with the main body 502 in position, the spacing element 512 may be inserted into the main body 502. The spacing element may define an annular hollow space adapted to accept the ferrule 422 therein as it is positioned in the axial direction over the busbar 404. Once the spacing element 512 is in position, the seal 510 may be inserted or slid into the other end of the main body 502. The seal 510 is fitted over an insulating layer of the busbar 404 for forming a seal therewith. An outer surface of the seal 510 sealingly contacts an inner surface of the main body 502. The seal 510 is axially retained or located via the spacing element 512, as shown. As should be understood, the use of the spacing element 512 (as distinct from the integral, inwardly extending stop on the cable end) permits the main body 502 to be formed from a single piece that can be slip-fit over the joint. Once positioned as illustrated, the end cap 506 is fitted (e.g., snap fitted) over the main body 502. This secures the position of the seal 510, ensuring reliable sealing and isolation of the joint from the external environment.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range.

Also, the indefinite articles “a” and “an” preceding an element or component of the invention are intended to be nonrestrictive regarding the number of instances, that is, occurrences of the element or component. Therefore “a” or “an” should be read to include one or at least one, and the singular word form of the element or component also includes the plural unless the number is obviously meant to be singular.

The term “invention” or “present invention” as used herein is a non-limiting term and is not intended to refer to any single embodiment of the particular invention but encompasses all possible embodiments as described in the application.

What is claimed is:

1. A conductor assembly, comprising:
a first conductive busbar;
a second conductive busbar; and
a flexible conductor electrically connected to exposed ends of the first busbar and the second busbar for establishing electrical communication therebetween.

2. The conductor assembly of claim 1, further comprising an electrically insulating flexible sleeve installed over the flexible conductor and covering the exposed end portions of each of the first and second busbars.

3. The conductor assembly of claim 2, wherein each of the busbars includes an insulating material covering the busbar between the exposed end portions thereof, wherein the flexible sleeve overlaps the insulating material on the ends of each of the busbars.

4. The conductor assembly of claim 3, further comprising a plurality of fasteners, each fastener fixing the insulating flexible sleeve proximate one of the covered end portions of each of the first and second busbars.

5. The conductor assembly of claim 2, further comprising heat shrink arranged about each end of the flexible sleeve and covering at least a portion of an insulation material arranged about the first busbar.

6. The conductor assembly of claim 5, further comprising a charging port for an electric vehicle, the second busbar adapted to selectively engage with a terminal of the charging port.

7. The conductor assembly of claim 6, further comprising:
a plug fitted over a portion of the second busbar and a portion of the flexible conductor, the plug adapted to be fitted to the charging port; and
a seal installed over the plug and is adapted to form a seal with the charging port of the electric vehicle, wherein the heat shrink is fitted over an end of the flexible sleeve adjacent the second busbar and at least partially over the plug.

8. The conductor assembly of claim 1, wherein the flexible conductor comprises a braided cable, a layered copper element or a multi-stranded wire.

9. The conductor assembly of claim 1, wherein the first and second busbars are electrically connected to the flexible conductor via one of ultrasonic welding or butt welding.

10. The conductor assembly of claim 1, wherein each of the first and second busbars are formed of aluminum, and the flexible conductor is formed of copper.

11. A conductor assembly, comprising:
a flexible conductor including a conductive core and a metallic shielding layer at least partially exposed on an exterior of the flexible conductor;
a first rigid busbar including a conductive aluminum core and a metallic shieling layer at least partially exposed on an exterior of the busbar, an exposed end of the flexible conductor and an exposed end of the busbar electrically connected at a joint; and
a first insulating assembly fitted over the joint.

12. The conductor assembly of claim 11, wherein the first insulating assembly includes an electrically isolating housing arranged over the joint.

13. The conductor assembly of claim 12, wherein the electrically isolating housing comprises a two-piece housing adapted to be snap-fit over the joint.

14. The conductor assembly of claim 13, wherein the first insulating assembly further includes a metallic shield sleeve arranged over the housing and electrically contacting the exposed metallic shielding layers of each of the first busbar and the flexible conductor.

15. The conductor assembly of claim 14, wherein the first insulating assembly further includes a plurality of fasteners, each fastener securing the shield sleeve over a respective one of the metallic shielding layers of the first busbar and the flexible conductor.

16. The conductor assembly of claim 15, wherein the first insulating assembly further includes heat shrink applied over the shield sleeve, the heat shrink extending to and arranged over an insulation material of each of the first busbar and the flexible conductor.

17. The conductor assembly of claim 11, further comprising a second rigid busbar electrically connected to another end of the flexible conductor with a second one of the insulating assemblies.

18. The conductor assembly of claim 11, wherein the flexible conductor comprises a stranded copper cable.
